(19) United States
(12) Patent Application Publication
(10) Pub. No.: US 2013/0300799 A1
(43) Pub. Date: Nov. 14, 2013

(54) INK JET RECORDING APPARATUS

(71) Applicant: SEIKO EPSON CORPORATION, Tokyo (JP)

(72) Inventors: Akira MIZUTANI, Shiojiri (JP); Toshihiro SHINBARA, Matsumoto (JP); Hiroshi MUKAI, Shiojiri (JP); Masakazu OHASHI, Shiojiri (JP)

(73) Assignee: Seiko Epson Corporation, Tokyo (JP)

(21) Appl. No.: 13/851,637

(22) Filed: Mar. 27, 2013

(30) Foreign Application Priority Data
May 14, 2012 (JP) 2012-110741
Nov. 30, 2012 (JP) 2012-262109

(51) Int. Cl. B41J 2/165

(52) U.S. Cl. CPC B41J 2/16505; B41J 2/16535
USPC 347/30; 347/29

(57) ABSTRACT

An ink jet recording apparatus includes at least: a print head that discharges ink jet recording ink from nozzles which are formed on a nozzle forming surface toward a recording medium; a wiping mechanism that wipes out ink which is attached to a nozzle forming surface using an absorbent material having an impregnating solution; and a cap member that adheres closely to the nozzle forming surface in a state in which a space is included in an area facing the nozzles, and removes at least ink of the space, and further includes the following characteristic (1) or (2). (1) Ink jet recording ink composition includes a first resin having a heat distortion temperature of 10° C. or less. (2) Ink jet recording ink composition includes a second resin and includes substantially no glycerin.

Priority is claimed under 35 U.S.C. §119 to Japanese Application No. 2012-110741 filed on May 14, 2012 and No. 2012-262109 filed on Nov. 30, 2012, which are hereby incorporated by reference in their entirety.

### BACKGROUND

1. Technical Field

The present invention relates to an ink jet recording apparatus.

2. Related Art

In the related art, a printing method using an ink jet recording system is performed by flying ink droplets and causing the ink droplets to be attached to a recording medium, such as paper. With innovative progress of an ink jet recording system technology in recent years, an ink jet recording apparatus using the ink jet recording system has been used in a high-definition image recording (image printing) field in which photograph or offset printing has been used until now.

If moisture and other volatile components which are included in discharged ink are evaporated in the ink jet recording apparatus, the viscosity of ink is raised (thickened). The thickened ink causes nozzles to be clogged, thereby generating poor discharge of ink. Since high-definition recording has been performed in recent ink jet recording, the number of discharged ink drops is an infinitesimal quantity of a few pLs, the diameters of nozzles which discharge ink are small, and energy which is necessary to discharge ink is small. Since the diameters of the nozzles are small and the ink discharge energy is small, the clogging of the nozzles greatly influences ink discharge. In addition, there is a case in which foam is mixed into nozzles or an ink supply path, thereby generating poor discharge. Further, when ink jet recording is performed using paper, a large amount of paper powder is generated by a paper feed operation in accordance with the recording. If so, there is a case in which the generated paper powder, and furthermore, a small amount of ink droplets, generated in accordance with surrounding dust and discharge, is attached to the forming surface of the nozzles of a print head which discharges ink (hereinafter, referred to as a “nozzle forming surface”). If foreign matters, such as ink, paper powder, and dust, are attached to the nozzles and the vicinity thereof, normal ink discharge is disturbed.

In order to prevent or solve such poor discharge due to thickened ink, foam mixture, and the attachment of foreign matters to a nozzle surface (a nozzle forming surface), an ink jet recording apparatus which includes a cleaning mechanism (a restoration mechanism) has been proposed.

For example, JP-A-7-290724 discloses an ink jet recording apparatus which includes a head cleaning mechanism which causes both the inner surface of a cap and a nozzle surface to wet easily with ink in such a way that both a contact angle θ1 between the ink and the inner surface of the cap and a contact angle θ2 between the nozzle surface and the ink are 90° or less and θ≦θ1, and further in which ink emitted to the cap from nozzles broadens into the cap and the nozzle surface, covers the clogged nozzles, and melts the clogging with ink.

However, when recording is performed in such a way that ink which includes resin (hereinafter, referred to as “color ink”) is mounted in the ink jet recording apparatus disclosed in JP-A-7-290724, a problem occurs in that continuous recording stability and cleaning performance are inferior.

### SUMMARY

An advantage of some aspects of the invention is to provide an ink jet recording apparatus which has excellent continuous recording stability and cleaning performance when recording is performed using color ink.

The inventors of the specification conducted an examination in order to solve the problem, and found the followings. First, in an ink jet recording apparatus on which color ink is mounted, in order to coat and fix the color ink on a recording medium in which it is normally difficult to absorb the color ink, a recording target surface is heated up to a degree of 45 to 60° C. using some method. At this time, a print head receives radiant heat from the recording target surface, and thus, a nozzle forming surface of a nozzle plate, which faces the recording medium, is heated. As a result, the nozzle forming surface is further heated than that of a normal ink jet recording apparatus, and it is found that, particularly, meniscus easily dries in non-discharge nozzles. In addition, the non-discharge nozzles have a tendency that ink dries and easily solidifies in the vicinity of the nozzles, and thus recording is unstable.

In addition thereto, when recording is performed using the color ink on a recording medium, such as fabric, which is extremely flexible, it is necessary to use resin which has extremely low heat distortion temperature and which is easily softened. Such resin has a tendency to have a strong adhesion property and be solidly attached to the head or a wiping member.

In addition, since the color ink has a coating property, landing is disturbed when the color ink returns from a thickened state. In addition, in the nozzles which perform discharge, tailing is easily generated due to, for example, the lowering of viscosity attributable to the rise of ink temperature, and the property of an organic solvent. As a result, satellites (minute ink drops obtained in such a way that tail parts are separated from ink droplets) are generated from the ink drops, and the satellites become mists and return to an upper side, thereby they easily attach to the nozzle forming surface. It is found that the satellites are generated when ink droplets corresponding to several drops are connected, and are easily generated as the viscosity of the ink is low. Here, the “mist” indicates extremely minute ink drops which are generated from the print head and float inside the ink jet recording apparatus without reaching the recording medium.

Further, since the color ink, which is suitable for being printed on a non-ink absorbable or low absorbable recording medium, such as plastics, realizes quick-drying, the color ink does not include a high boiling point solvent (in particular, glycerin) in many cases. When recording is performed by mounting such quick-drying color ink on the ink jet recording apparatus disclosed in JP-A-7-290724, foam is easily generated in the cap when the print head is cleaned, and a main solvent, such as water, promptly volatilizes, with the result that a percentage of organic solvent in the ink composition increases, and thus the heat distortion temperature of resin is lowered. Therefore, the color ink is attached to the lip unit of the cap which comes into contact with the nozzles, and solidification is prompted. As a result, it is found that the print head is difficult to sufficiently adhere closely to the cap, and cleaning becomes insufficient.

In addition, the color ink which is suitable for printing performed on the recording medium, such as fabric, which has high absorbability and abundant flexibility has a tendency to include resin which is extremely easy to be coated as described above. When recording is performed in such a way that the color ink having high adhesion and coated properties is mounted on the ink jet recording apparatus disclosed in JP-A-7-290724, foam is easily generated in the cap when the print head is being cleaned, and the color ink is attached to the lip unit of the cap which comes into contact with the nozzles, and solidifies. As a result, it is found that the print head does not adhere sufficiently close to the cap, and cleaning becomes insufficient.

As described above, since the mists are attached to the vicinity of the nozzles and the nozzles which are discharging the color ink easily solidify, there is a tendency that recording is unstable. In addition, based on the facts that ink which is being used is easily coated and solidifies, mists which returned to the nozzle forming surface solidify, with the result that ink discharging is disturbed, and thus recording (image forming) becomes unstable. Further, if the print head (more properly, the nozzles) to which the above-described color ink is attached is cleaned using the cap, the color ink solidifies in the lip unit (upper edge portion) of the cap, cleaning performance is inferior, and thus the recording is easy to be unstable.

Here, the inventors of the specification further conducted a great deal of examination. As a result, it is found that, when cleaning is performed using the cap, continuous recording stability is excellent because it is possible to securely emit the thickened color ink from the nozzles to the cap and to remove the returned mists of color ink by the ink jet recording apparatus which operates a specific wiping mechanism, and the cleaning performance is excellent because it is possible to prevent the color ink emitted to the cap from solidifying in the lip unit of the cap. Further, it is found that the problem can be solved by an ink jet recording apparatus at least including: a print head that discharges fast-drying color ink from nozzles which are formed on a nozzle forming surface toward a recording medium; a wiping mechanism that wipes out ink which is attached to a nozzle forming surface using a fabric wipe having an impregnating solution; and a cap member that adheres closely to the nozzle forming surface in a state in which a space is included in an area facing the nozzles, and removes at least ink of the space, and the present invention has been completed.

That is, the present invention is as follows:

[1] According to an aspect of the invention, there is provided an ink jet recording apparatus including at least: a print head that discharges ink jet recording ink from nozzles which are formed on a nozzle forming surface toward a recording medium; a wiping mechanism that wipes out ink which is attached to a nozzle forming surface using an absorbent material having an impregnating solution; a cap member that adheres closely to the nozzle forming surface in a state in which a space is included in an area facing the nozzles, and removes at least ink of the space. The ink jet recording apparatus further includes the following characteristic (1) or (2). (1) Ink jet recording ink composition includes a first resin having a heat distortion temperature of 10° C. or less. (2) Ink jet recording ink composition includes a second resin and includes substantially no glycerin.
[2] In the ink jet recording apparatus of [1], in a case where the ink jet recording apparatus includes the characteristic (2), the heat distortion temperature of the first resin may be 60° C. or greater, and the ink jet recording apparatus may further include a heating mechanism that heats a recording medium which is transported to a position facing the print head.
[3] In the ink jet recording apparatus of [1], in a case where the ink jet recording apparatus includes the characteristic (1), and a second resin content of the ink composition may be 3 mass % or greater.
[4] In the ink jet recording apparatus of any one of [1] to [3], at least any one of the ink jet recording ink or the impregnating solution may include a defoamer.
[5] In the ink jet recording apparatus of any one of [1] to [4], the cap member may make a smaller contact angle with the ink jet recording ink than the nozzle forming surface.
[6] In the ink jet recording apparatus of any one of [1] to [5], a nozzle plate cover which covers at least a part of the nozzle forming surface may be provided on the nozzle forming surface, and a lip unit of the cap member may come into contact between the nozzle plate cover and the nozzles.
[7] In the ink jet recording apparatus of any one of [1] to [6], the cap member may include: a cleaning cap which sucks the ink jet recording ink in the print head in a state in which at least a part of the nozzle forming surface is covered; and a release cap which comes into contact with the nozzle forming surface and covers at least the part of the nozzle forming surface in a release state in which a recording operation of the ink jet recording apparatus is stopped, unlike the cleaning cap.
[8] In the ink jet recording apparatus of [7], when the recording apparatus proceeds to the release state, that is, before at least the part of the nozzle forming surface is covered by the release cap, ink which is attached to the nozzle forming surface may be wiped out using the wiping mechanism.

### BRIEF DESCRIPTION OF THE DRAWINGS

The invention will be described with reference to the accompanying drawings, wherein like numbers reference like elements.

FIG. 1 is a block diagram illustrating the configuration of an ink jet recording apparatus according to an embodiment of the present invention.

FIG. 2 is a perspective diagram illustrating a schematic configuration of the ink jet recording apparatus according to the embodiment of the present invention.

FIG. 3 is a schematic diagram illustrating the configurations of a cap member and a suction pump connected to the cap member, which are included in the ink jet recording apparatus according to the embodiment of the present invention.

FIGS. 4A and 4B are schematic diagrams illustrating the nozzle forming surface of the ink jet recording apparatus according to the embodiment of the present invention.

### DESCRIPTION OF EXEMPLARY EMBODIMENTS

Hereinafter, an embodiment in order to implement the present invention will be described in detail. In addition, the present invention is not limited to an embodiment below, and various modifications are possible without departing from the gist of the present invention.

In the specification, “(meth)acrylate” means at least one of acrylate and methacrylate corresponding to the acrylate, “(meth)acrylic” means at least one of acrylic and methacrylic corresponding to the acrylic, and “(meth)acryloyl” means at least one of acryloyl and meth acryloyl corresponding to the acryloyl.

### Ink jet Recording Apparatus

An embodiment of the present invention relates to an ink jet recording apparatus (hereinafter, simply referred to as a “recording apparatus”).

As the ink jet recording apparatus, an on-carriage type serial printer (hereinafter, simply referred to as a “printer”) is exemplified and described with reference to the accompanying drawings. Here, the serial printer performs recording in such a way that a print head (hereinafter, referred to as a “head”) reciprocates in the direction which crosses the transport direction of a recording medium. Here, the on-carriage type serial printer mounts an ink cartridge (an ink tank) together with the head on a carriage, and the carriage detachably maintains the ink cartridge which accommodates color ink.

In addition, hereinafter, since each member has a size which can be recognized in the drawings which are used for description, the scale of each member may be appropriately modified.

### 1. Configuration of Apparatus

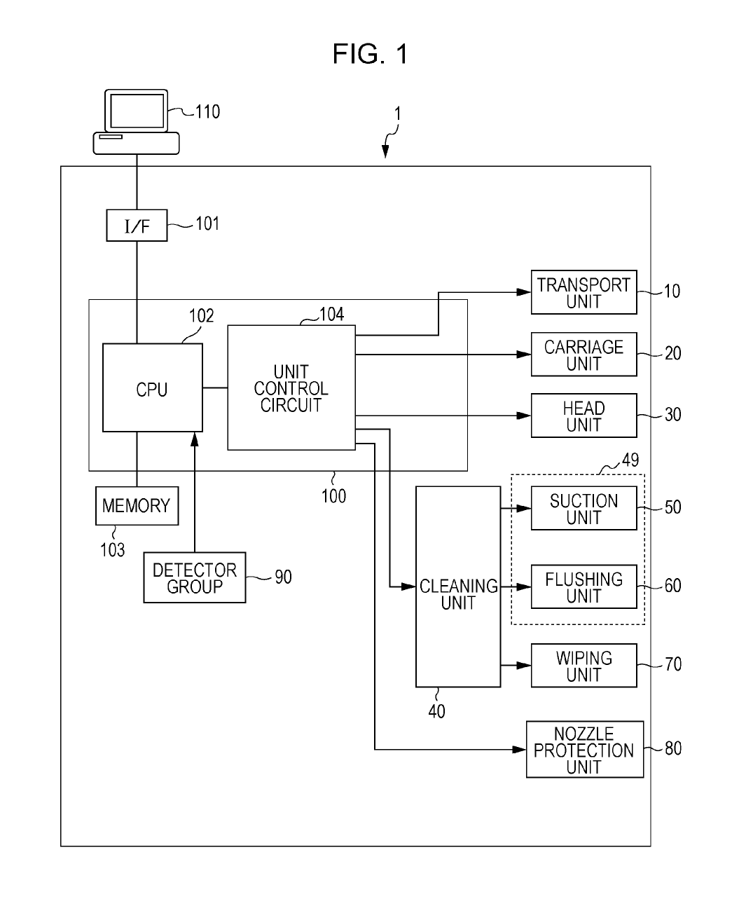

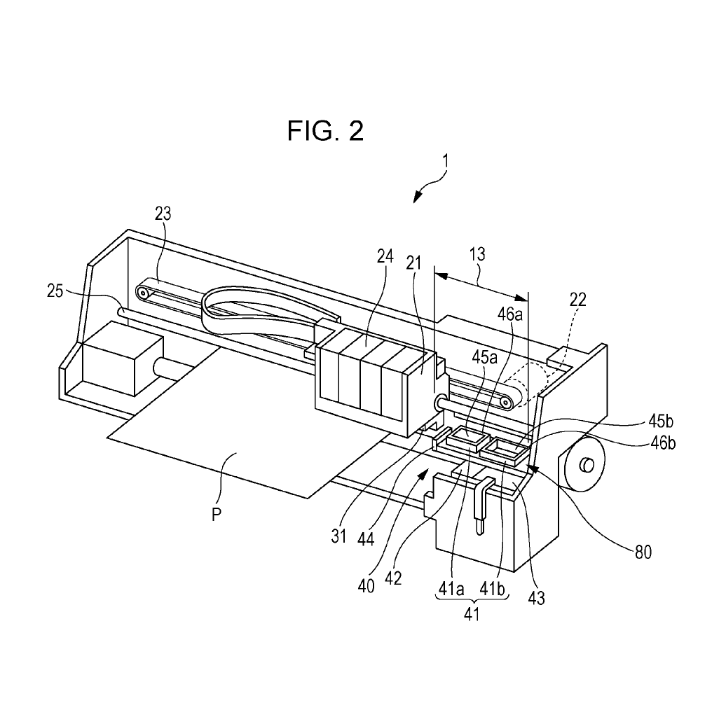

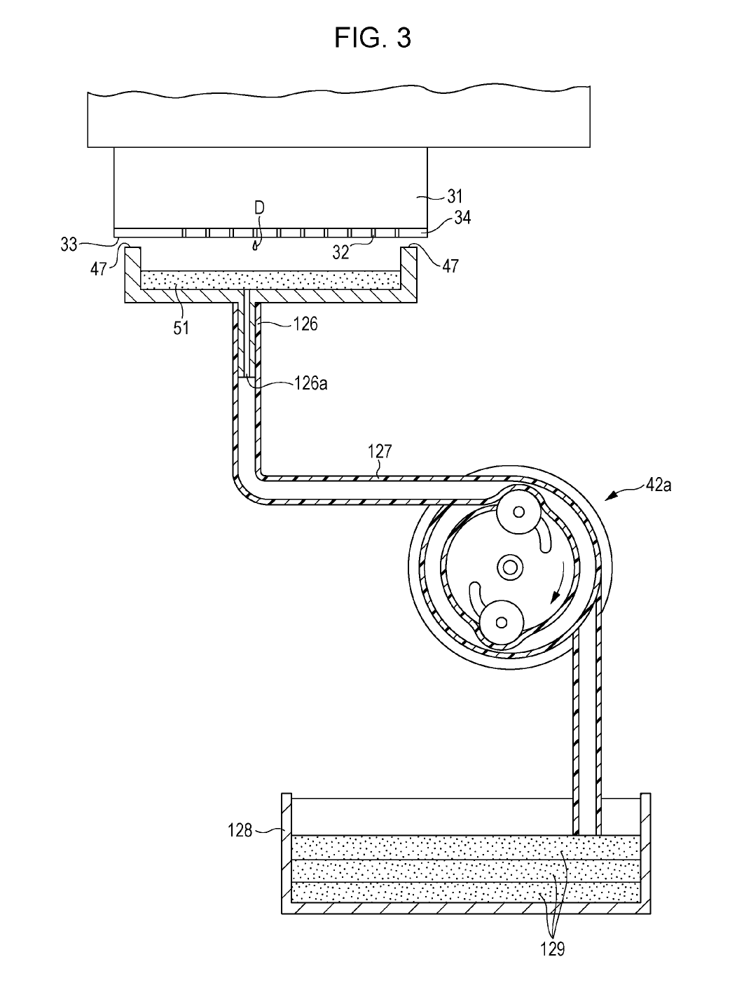

FIG. 1 is a block diagram illustrating the configuration of a printer 1. FIG. 2 is a perspective diagram illustrating a schematic configuration of the printer 1. FIG. 3 is a schematic diagram illustrating the configurations of a cap member which is included in the printer 1 and a suction pump which is connected to the cap member.

The printer 1 according to the embodiment is an apparatus which discharges ink jet recording ink (color ink) which includes resin toward a recording medium P, thereby forming an image on the recording medium P. Here, the printer 1 according to the embodiment can form an image using various colors of ink. For example, the printer 1 forms an image using CMYK four-color ink or forms a base, which gives excellent concealment to the recording medium P, using white ink. Further, these CMYK and white ink are over painted with clear ink, and thus it is possible to increase gloss.

The printer 1 includes a transport unit 10, a carriage unit 20, a head unit 30, a cleaning unit 40, a capping unit 49 (which includes a suction unit 50 and a flushing unit 60), a wiping unit 70, a nozzle protection unit 80, a detector group 90, and a controller 100. The printer 1 which received recording data from a computer 110 which is an external apparatus controls each of the units, that is, the transport unit 10, the carriage unit 20, the head unit 30, the cleaning unit 40, the capping unit 49 (the suction unit 50 and the flushing unit 60), and the wiping unit 70 using the controller 100. The controller 100 controls each of the units based on the recording data which is received from the computer 110, and prints an image on the recording medium P. The situation in the printer 1 is monitored by the detector group 90, and the detector group 90 outputs a result of detection to the controller 100. The controller 100 controls each of the units based on the result of detection which is output from the detector group 90.

The transport unit 10 is used to transport the recording medium P in a predetermined direction (hereinafter, referred to as a “transport direction” or a “sub scanning direction”). The transport unit 10 includes a paper feed roller (not shown), a transport motor (not shown), a transport roller (not shown), a platen (not shown), and a paper ejection roller (not shown). The platen (not shown) supports the recording medium P which is being recorded, and the recording medium P is fed thereon by driving a paper feed motor (not shown).

The carriage unit 20 is a movement mechanism which moves, that is, scans the head 31 in a direction which crosses the transport direction (sub scanning direction) (hereinafter, referred to as a “movement direction” or a “main scanning direction”) while discharging the color ink to the recording medium P on which stops at a recording area. The carriage unit 20 includes a carriage 21, a carriage motor 22, and an ink cartridge 24. The carriage 21 includes the head 31 and the ink cartridge 24 therein, and is connected to the carriage motor 22 through the timing belt 23. The ink cartridge 24 is mounted on the upper portion of the printer 1, and the head 31 is installed on the lower surface of the ink cartridge 24. The ink cartridge 24 stores liquid color ink and supplies the color ink from the ink cartridge 24 to the head 31. Further, the carriage 21 reciprocates along a guide shaft 25 by the carriage motor 22 in a state in which the carriage 21 is supported by the guide shaft 25 which crosses the transport direction. The guide shaft 25 supports the carriage 21 such that the carriage 21 can reciprocate in the shaft line direction of the guide shaft 25.

The head unit 30 discharges the color ink to the recording medium P. The head unit 30 includes a head 31 which receives the supply of the color ink from the ink cartridge 24, and discharges the color ink toward the recording medium P from nozzles 32 which are formed on the nozzle forming surface 33. The head 31 includes nozzles 32 which discharge the color ink, a nozzle plate 34 which is installed on the lower surface of the head 31, and a nozzle forming surface 33 on which the nozzles 32 are formed, cavities (not shown) which give driving force for discharge, a reservoir (not shown) which prevent ink from flowing backward, and a piezoelectric element (not shown) which forms color ink droplets D suitable for discharge. The head is provided on the carriage 21 such that the nozzle forming surface 33 of the nozzle plate 34, which is formed of water-repellent silicon, faces the recording medium P. Therefore, if the carriage 21 moves in the movement direction, the head 31 moves in the movement direction. Further, when the head 31 is moved in the movement direction, the color ink is discharged to the recording medium P. Therefore, a dot array along the movement direction is formed on the recording medium P. In this manner, the head 31 discharges the color ink to the recording medium P, and thus it is possible to simplify the recording apparatus. The nozzle forming surface 33 corresponds to a surface of the nozzle plate 34, which faces the recording medium P. The material of the nozzle plate is not limited to the silicon, and it is possible to use, for example, metal such as SUS and a resin such as a polyimide.

The cleaning unit 40 includes the capping unit 49, which has at least the suction unit 50 and flushing unit 60, and the wiping unit 70, and causes each of these units to be appropriately operated under the control of the controller 100. The cleaning unit 40 includes at least a cleaning cap member 41a which sucks the color ink in the head 31 in a state in which at least a part of the nozzle forming surface 33 is covered of the cap member 41, a cleaning cap lifting mechanism (not shown), a suction pump 42, a waste tank 43, a fabric wiper 44 as wiping means. The cleaning cap 41a is a bottomed box which has an opening section 45a on the upper portion thereof, and is capable of blocking the nozzles 32 of the head 31 from air in such a way as to adhere close to the nozzle forming surface 33. The suction pump 42 communicated with the inside of the cap of the cleaning cap 41a, and it is possible to generate negative pressure inside the cleaning cap 41a using the suction pump 42.

The capping unit 49 includes the cap member 41, and removes the color ink by adhering the cap member 41 to the nozzle forming surface 33. As shown in FIG. 3, the cap member 41 adheres closely to the nozzle forming surface 33 while having a space in an area which faces the nozzles 32, and removes at least the color ink in the space. More specifically, since a lip unit 47 (which corresponds to the upper edge 46a of the cleaning cap 41a in FIG. 2) comes into contact with the nozzle forming surface 33 of the nozzle plate 34, the cap member 41 adheres closely to the nozzle forming surface 33. Further, when the color ink in the space, that is, the color ink inside the cap member 41, (cleaning cap 41a) is sucked and removed, the pressure of the space is reduced (negative pressure), with the result that the contact portion which adheres closely to is sealed, thereby preventing air from flowing from the contact portion.

In addition, the cap member 41 is a tray-shaped member in which the upper surface thereof is open, and the lip unit 47 which is formed by an elastic member, such as elastomer, is prepared in a housing which is formed of denatured polyphenylene ether (PPE) resin. In addition, it is possible to use butyls, acrylonitrile-butadiene rubbers (NBRs), silicons, urethanes, butadienes, poly esters, vinyl chlorides, acrylics, amides, and styrenes as the elastomer of the lip unit 47 of the cap member 41. In addition, the nozzle plate 34 is formed with a water repellent film in which a surface, that is, the nozzle forming surface 33 is water-repellent processed.

Here, it is preferable that the contact angle of the cap member 41 (more specifically, the lip unit 47, hereinafter, it is the same in this paragraph) be less than that of the nozzle plate 34 (more specifically, the nozzle forming surface 33, hereinafter, it is the same in this paragraph). In other words, it is preferable that the nozzle plate 34 have better water repellency than the cap member 41. In this case, an effect can be obtained in which ink does not easily remain on the nozzle plate. In addition, the water-repellent silicon which configures the nozzle plate 34 is at excellent in water repellency compared to rubber such as butyl rubber which configures the cap member (a method of manufacturing a silicon nozzle plate, which has water repellency, that is, which is attached to a water-repellent film, will be described in an embodiment below). In addition, when a water repellent film is formed on the surface of the nozzle forming surface 33, the nozzle forming surface 33 includes the water repellent film. As a material of the water repellent film, materials, such as silicons and fluorines, may be exemplified.

When the contact angle of the lip unit 47 is less than the contact angle of the nozzle plate 34, a cap cleaning member which is formed of a material, the contact angle which is less than the contact angle of the lip unit 47, may be prepared at a place which is different from that of the head 31 in the recording apparatus. In this case, the cap member 41 is moved in a state in which ink is attached to the lip unit 47, and comes into contact with the cap cleaning member (as necessary, rubs both). Therefore, it is possible to transfer the ink on the lip unit 47 to the cap cleaning member, and thus it is possible to clean the nozzle plate 34 and the cap member 41.

Although not limited to the capping unit 49 below, for example, the suction unit 50 and the flushing unit 60 may be exemplified. The suction unit 50 of them sucks the color ink in the nozzles 32 using the suction pump 42 (described later).

The flushing unit 60 solves clogged nozzles 32 by discharging the color ink from the nozzles 32 of the head 31. More specifically, the flushing unit 60 moves the head 31 to an ink receptor (not shown) which is formed by a tray, urethane foam, sponge, and fabric or paper having ink absorbability, is frequently executed (normally, for each single pass, that is, whenever the head 31 or the recording medium P scans once), performs the non-recording purpose discharge of the color ink from the head 31 to the ink receptor, and cleans the nozzles 32 of the head 31.

Here, the “non-recording purpose discharge” in the specification can be said to be “flush”. The “non-recording purpose discharge” does not mean discharge into the recording medium P to form an image but means discharge into the ink receptor to remove color ink that is excessively heated so as to be the cause of clogging.

The wiping unit 70, which corresponds to a wiping mechanism, wipes out ink attached to the nozzle forming surface 33 using a fabric wiper 44 which has an impregnating solution, and removes the color ink attached to the nozzle forming surface 33.

The nozzle protection unit 80 includes at least a release cap 41b and a release cap lifting mechanism (not shown). The release cap 41b comes into contact with the nozzle forming surface 33 in a release state, in which a recording operation of the printer 1 stops, and covers at least a part of the nozzle forming surface 33. Here, the release cap 41b is different from the cleaning cap 41a. The nozzle protection unit 80 has a function of covering the nozzle forming surface 33 using the release cap 41b when the printer 1 becomes the release state. When the printer 1 is being in the release state, the evaporation of the moisture of the color ink in the nozzles 32 is suppressed by covering the nozzle forming surface 33 using the release cap 41b, thereby preventing the color ink from being thickening. In addition, it is possible to prevent foreign matters, such as dust, from attaching to the nozzle forming surface 33. The release cap 41b is a bottomed box which has an opening section 45b at the upper portion thereof. If the release cap 41b is raised by a release cap lifting mechanism (not shown), the edge of the opening section 45b, that is, the upper edge 46b of the release cap 41b comes into contact with a cover member (not shown) which covers the head 31 throughout the side surface (not shown) of a head body (not shown) from the peripheral edge of the nozzle forming surface 33. As described above, the nozzle protection unit 80 causes the release cap 41b to come into contact with the cover member (not shown), and covers the nozzle forming surface 33 such that the nozzle forming surface 33 is bolcked from air.

In addition, the “release state” in the specification refers to a state in which a recording operation is not performed during a time that a subsequent recording operation is performed after a recording operation ended based on a recording command which is output from the computer 110 to the printer 1. In detail, for example, a state in which the power switch of the printer 1 is turned off after a recording operation ends and the printer 1 is not electrically conducted is the release state. In addition, even in a case in which power is turned on, a state, in which a recording operation is not performed during a period until a new print command is performed on the printer 1 after a recording operation ends, is the release state. In the release state, if the nozzles 32 is laid in the air for a long time, problems occur in that the moisture of the color ink in the nozzles 32 evaporates and the color ink thickens and clog is generated in the nozzles 32. In order to prevent the problems from occurring, the printer 1 is configured to include the nozzle protection unit 80, cover the nozzle forming surface 33 using the release cap 41b in the release state, and suppress the evaporation of the moisture of the color ink in the nozzles 32, and thus it is possible to prevent the color ink from being thickened or prevent an foreign matter from attaching to the nozzle forming surface 33.

The detector group 90 includes a linear encoder (not shown), a rotary encoder (not shown), a paper detection sensor (not shown), and an optical sensor (not shown). The linear encoder detects the position of the movement direction of the carriage 21. The rotary encoder detects the amount of rotation of the transport roller (not shown). The paper detection sensor (not shown) detects the position of the front end of a paper (recording medium P) which is being fed. The optical sensor (not shown) detects whether or not the recording medium P is present using a light emitting unit and a light receiving unit which are attached to the carriage 21. Further, the optical sensor (not shown) can detect the position of the front end of the recording medium P while being moved by the carriage 21 and can detect the width of the recording medium P. In addition, the optical sensor (not shown), depending on the situation, can detect the front end of the recording medium P (downstream end of the transport direction and called upper end) and the back end (upstream end of the transport direction and called lower end) thereof.

The controller 100 is a control unit (control section) to control the printer 1. The controller 100 includes an interface unit 101, a CPU 102, a memory 103, and a unit control circuit 104. The interface unit 101 transmits and receives data between the computer 110 which is an external apparatus and the printer 1. The CPU 102 is an arithmetic processing unit to control the entire printer 1. The memory 103 secures an area to store the program of the CPU 102 and an operation area, and includes a storage device, such as a RAM or an EEPROM. The CPU 102 controls each of the units through the unit control circuit 104 based on a program which is stored in the memory 103.

### 2. Operation of Apparatus

The printer 1 shown in FIGS. 1 to 3 is configured as described above. Hereinafter, an operation of the printer 1 will be described in detail.

First, the transport unit 10 transports the recording medium P on the platen (not shown) in the transport direction to an area in which the droplets D of the color ink which is discharged from the nozzles 32 of the head 31 (refer to FIG. 3) can be landed, that is, an area on which the discharged the color ink is landed (attached).

Thereafter, the head unit 30 discharges the color ink from the nozzles 32 of the head 31 toward the recording medium P, and the color ink is landed on the recording target surface thereof. A well-known method in the related art can be used as a discharge method. If a method of discharging droplets using vibration of a piezoelectric element (a recording method of using a head which forms ink droplets through mechanical deformation of an electrostrictive device) is used, it is possible to perform excellent recording. In addition, when the recording target surface of the recording medium P is heated to a predetermined temperature as described above, moisture included in the color ink which is discharged on the recording target surface of the recording medium P is rapidly evaporated and scattered, and a coated film is formed by resin included in the color ink. Therefore, it is possible to obtain a high-quality image with little ink bleed in which an ink dry substance is solidly settled (adhered) on the recording target surface of the recording medium P.

Here, when the color ink is discharged toward the recording medium P, satellites are generated from the color ink in the nozzles 32 in which discharge is performed, and thus it is easy to mist over. Since the mist does not reach the recording medium P and returns to upper portion, the mist has a tendency to be attached to the nozzle forming surface 33. For example, since the temperature of the nozzle forming surface 33 rises up to a degree of 40 to 55° C. under the influence of radiant heat from the heated recording medium P, it is easy for the mist attached to the nozzle forming surface 33 and driven from the color ink to dry and solidify (harden).

By contrast, nozzles 32 in which discharge is not performed for a long time, in particular, in a part of nozzle opening 39, the color ink dries and easily solidifies. As a result, the nozzles 32 in which discharge is not performed for a long time are easily clogged. As described above, there is a possibility that all the nozzles 32 are clogged because the color ink dries or mist solidifies in the vicinity of the nozzles 32 or on the nozzle forming surface 33 regardless of discharge, there is a risk that poor discharge occurs.

Here, it is possible to prevent the nozzles 32 from being clogged as described above by performing the cleaning operation that includes a capping operation, which includes at least a suction operation and a wiping operation (wiping process) to remove ink inside the cap member 41 by causing the cap member 41 to adhere closely to the nozzle forming surface 33, and a flushing operation (flushing process) under the control of the controller 100.

First, the flushing operation (the flushing process) will be described. Since the solidification of the color ink, which may occur in the nozzles 32 which performs the discharge operation, is relatively small in scale because an image is recorded by discharging ink and fresh ink is supplied by normally emitting the ink. Even in nozzles 32 in which discharging is not performed, there is a possibility that the dry and solidification of the color ink hardly progresses immediately after idle running for a single pass end. Therefore, the controller 100 operates the flushing unit 60 (flushing process) on all the nozzles 32 at regular time intervals, preferably, when power is turned on and for each 1-pass recording operation, and, further preferably, for each 1-pass recording operation. The head (carriage 21) is moved to the ink receptor (not shown) which is provided on the outside of the platen (not shown) along the guide shaft 25. Further, the color ink is discharged toward the ink receptor from the non-recording purpose head 31, and nozzles 32 are cleaned. The amount of non-recording purpose discharge may enable the color ink in the vicinity of the nozzles 32 to be emitted.

Subsequently, the wiping operation (wiping process) will be described. Since the solidification of the color ink, which may occur in the nozzles 32 to perform the discharge operation, occurs not only in the vicinity of the nozzles 32 but also the nozzle forming surface 33 near to the nozzles 32 due to mist in many cases, the solidification ranges in a relatively-massive and broad area. In this case, it is possible to sweep away the ink solidification substance which is attached to the nozzle forming surface 33 in such a way that the controller 100 wipes out ink by operating the wiping unit 70 at regular time intervals when recording is being performed, before a large amount of mist which is returned to the nozzle forming surface 33 is accumulated.

The wiping process is performed after the flushing process which may be performed at regular time intervals, and thus it is possible to remove mist which is generated from satellites when recording is being performed, and it is possible to remove mist which may be generated by the flushing process. In particular, it is preferable that a case in which a large amount of mist is attached to the nozzle forming surface 33 be detected, and the wiping unit 70 be operated. As described above, the wiping process is to wipe out ink which is attached to the nozzle forming surface 33 by imposing a fabric wiper (an example of an absorbent material) 44 on the nozzle forming surface 33. Therefore, it is possible to effectively remove mist which is attached to the nozzle forming surface 33 and the color ink which dried or might dry in the vicinity of the nozzles 32, and thus continuous recording stability is excellent.

In the embodiment, an absorbent material is used instead of a blade wiper which is made of rubber. The absorbent material (for example, the fabric wiper 44) can effectively wipe out the solidification substance of ink which is attached to the nozzle forming surface 33, compared to the blade wiper. In addition, it is possible to effectively wipe out the solidification substance of ink which is attached between an irregular and uneven nozzle plate cover and the nozzle forming surface 33. In addition, since impregnating solution which has predetermined composition is included in the wiping member in the embodiment, it is necessary to use the fabric wiper 44 which can include a sufficient amount of impregnating solution instead of the blade wiper which hardly includes the impregnating solution. In addition, fabric, cotton, and sponge may be exemplified as absorbent materials. More preferably, fabric is used. Hereinafter, description will be made by using fabric in a specific example.

When the impregnating solution is further described, the fabric wiper 44 according to the embodiment includes the impregnating solution, and thus it is possible to greatly raise the recovery efficiency of ink on the nozzle forming surface 33.

Although timing that the impregnating solution is included in the fabric wiper 44 is not particularly limited, for example, a case in which the impregnating solution is perfused in advance before the fabric wiper 44 is transported using reel (not shown) or a case in which the impregnating solution is perfused when the fabric wiper 44 is being transported may be exemplified.

Subsequently, the suction operation will be described. As shown in FIG. 2, the controller 100 causes the head 31 to move to a non-print area 13 and to be positioned immediately above the cleaning cap 41a. Further, the cleaning cap 41a is raised by a cleaning cap lifting mechanism (not shown) which is arranged under the cleaning cap 41a, the edge of the opening section 45a of the cleaning cap 41a, that is, the upper edge 46a of the cleaning cap 41a comes into contact with (adheres closely to) the nozzle forming surface 33, and thus the nozzles 32 are sealed inside the cleaning cap 41a. Further, negative pressure is generated in the cleaning cap 41a by the suction pump 42, and the ink in the nozzles 32 is sucked into the cleaning cap 41a and emitted. It is possible to emit thickened ink of the nozzles 32 to the outsides of the nozzles 32 by performing the suction operation, like the flushing operation.

The upper edge 46a of the cleaning cap 41a (which corresponds to the lip unit 47 in FIG. 3) is formed by the above-described foamable rubber, and is configured such that the whole upper edge 46a can adhere closely to the nozzle plate 34 (refer to FIG. 3) when contact is made with in the contact section. Therefore, when the upper edge 46a comes into contact with the nozzle plate 34 and the negative pressure is generated in the cleaning cap 41a, it is possible to prevent the inflow of air from the contact section between the upper edge 46a and the nozzle plate 34. Therefore, it is possible to certainly generate negative pressure, which is necessary to suck ink in the nozzles 32, in the cleaning cap 41a.

As described above, the lip unit 47 (upper edge 46a) in FIG. 3, which is formed of a material such as butyl rubber, is a region to which ink is attached and which easily solidifies. If ink solidifies in the lip unit 47, it is difficult that the lip unit 47 sufficiently adheres closely to the nozzle plate 34 in the contact section, and air flows therebetween, and thus a problem occurs in that it is difficult to maintain negative pressure. In contrast, according to the embodiment, after the wiping process is performed by the fabric wiper 44 which includes the impregnating solution having predetermined composition, the impregnating solution remains on the nozzle plate 34 (the nozzle forming surface 33). Therefore, it is possible to effectively prevent the solidification of the ink of the lip unit 47 by moistening the ink of the lip unit 47 of the cap member 41 when capping is performed.

The suction operation will be described in further detail with reference to FIG. 3. An ink absorber 51 is provided inside the cap member 41. The ink absorber 51 has high ink retention, and is prepared using non-woven fabric, such as felt. By contrast, an emission unit 126 which emits ink accumulated in the cap member 41 protrudes downward in the bottom wall of the cap member 41, and an emit path 162a is formed inside the emission unit 126. One end of an emission tube (excretory tube) 127 which is formed of a flexible material is connected to the emission unit 126, and the other end of the emission tube 127 is inserted into waste ink tank 128.

Here, a waste ink absorber 129 which is formed of a porous member is accommodated in a waste ink tank 128, withdrawn ink is absorbed by the waste ink absorber 129. In addition, the waste ink tank 128 is provided under the platen (not shown).

A tube pump-type suction pump 42a is provided between the cap member 41 and the waste ink tank 128. The negative pressure is generated inside the cap member 41 by the sucking force of the suction pump 42a. More specifically, the cap member 41 (more properly, the lip unit of the cap member 41) adheres closely to the nozzle forming surface 33 of the head 31, the suction pump 42a is driven in a state in which the cap member 41 covers the nozzle forming surface 33, and a space which is covered by the cap member 41 is caused to be a negative pressure state, thereby compulsorily discharging ink from each of the nozzles 32 toward the cap member 41. Thickened ink and bubbles in the nozzles 32 are compulsorily discharged by performing the suction operation. In addition, although not limited to the cleaning method below, for example, a pressurization cleaning method of discharging ink by pressurizing ink on the upstream side of the head 31 may be exemplified.

In addition, since the cap member 41 (more properly, the lip unit 47) adheres closely to the nozzle forming surface 33 of the head 31, the cap member 41 shown in FIG. 3 corresponds to the cleaning cap 41a shown in FIG. 2. In addition, the above-described release cap 41b may have the same structure and operation as the cap member 41 shown in FIG. 3.

The suction process enables the forcible discharge of thickened ink and bubbles in the nozzles 32 but requires a time compared to the wiping process and the flushing process. Therefore, the suction process is supposed to be performed when there is a risk that poor recording may be generated, such as a case in which the recording process is not performed for a long time, or a case in which poor recording is generated and a user makes a request.

In addition, when the suction operation is performed, the controller 100 drives the suction pump 42a for a predetermined time while causing the cap member 41 to adhere closely to or separate from the head 31.

As described above, when the controller 100 detects the using state and the clogging state of the nozzles 32, and appropriately uses the capping operation, such as the suction operation and the wiping operation (the wiping process), and the cleaning operation which includes the flushing operation (flushing process), it is possible to prevent the color ink from solidifying in the nozzles 32 of the head 31 and prevent the nozzles 32 from being clogged while high-speed print is secured, and, furthermore, it is possible to prevent dead pixel from being generated in a part of an image which is formed on the recording target surface of the recording medium P using the clogged head 31.

The use of the cleaning operation, more specifically, a preferable example of the control of the cleaning operation performed by the controller 100, will be described in detail. First, in the cleaning operation when recording starts, thickened ink in the head 31 is removed by performing the flushing operation, and, thereafter, the wiping operation of removing mist and dust on the nozzle forming surface 33 is performed. With regard to a short-term cleaning operation when recording is being performed, the flushing operation may be used. In addition, with regard to a long-term cleaning operation when recording is being performed, a large amount of mist is attached to the nozzle forming surface 33 as the recording operation is continued. Therefore, in addition to the flushing operation, the wiping operation may be performed for the purpose of clean maintenance of the nozzle forming surface 33. In addition, with regard to the cleaning operation performed when errors occur in the printer 1, at least the suction operation is performed, and, thereafter, the wiping operation may be combined and operated by request.

In addition, when recording ends, the nozzle forming surface 33 may be cleaned by the wiping operation, and the head 31 may be released in the release cap 41b. Before suction is performed in the cleaning cap 41a, it is possible to cleanly maintain the nozzle forming surface 33 by performing the wiping operation, it is possible to transfer the impregnating solution to the lip unit 47 of the cap member 41 because the impregnating solution remains on the nozzle forming surface 33, and it is possible to cause ink of lip unit 47 not to easily solidify.

In addition, white color ink has a tendency to be enormously discharged when viewed from a background concealment. In this case, the amount of mist becomes enormously great. At this time, in a case of white color ink composition which includes a titanic dioxide pigment having an average particle size of 200 nm or greater, a pigment density of the ink composition of 5 mass % or greater, and a Mohs hardness of approximately 6, it is easy to promote the solidification of the nozzle forming surface. When the solidification proceeds, suction inferiority due to the cap member 41 and risk of cutting a water repellent film when erasion is performed by the wiping operation occur. Therefore, after the nozzle forming surface 33 is made be cleaner by performing the wiping operation, the head 31 may be released in a release cap 41b.

In addition, when the amount of discharge is less, the wiping operation may not be performed when movement is made to a release cap. In this case, it is preferable that a mechanism which detects the amount of discharge be included.

### 3. Recording Medium

The recording apparatus according to the embodiment is particularly proper to ink jet recording which uses a recording medium or fabric having non-ink absorbability or low absorbability. More specifically, as will be described later, color ink which is used in the embodiment is proper to ink jet recording which is performed on a recording medium or fabric having non-ink absorbability or low absorbability based on the composition thereof.

In the specification, the “recording medium having non-ink absorbability or low absorbability” indicates a “recording medium which has an amount of water absorption of 10 mL/m² or less from when touch starts to 30 msec^{1/2} in Bristow method”. The Bristow method is the most popular method as a method of measuring the amount of liquid absorption for a short time, and is introduced in JAPAN TAPPI. The details of a test method are described in “paper and paper board-liquid absorbability test method-Bristow method” of “JAPAN TAPPI, paper pulp test method No. 51 (2000)”.

Although not limited to the non-ink absorbable recording medium below, for example, a medium which coats plastic on a base material, such as a plastic film and paper on which a surface process is not performed for ink jet recording (that is, on which an ink absorption layer is not formed), and a medium to which a plastic film adheres may be exemplified. Although the plastic is not particularly limited, for example, polyvinyl chloride, polyethylene terephthalate, polycarbonate, polystyrene, polyurethane, polyethylene, and polypropylene may be exemplified. As a low ink absorbable recording medium, a printing stock sheet, such as art paper, coated paper, or mated paper, may be exemplified.

Although not limited to the fabric below, for example, natural fiber or synthetic fiber, such as silk, cotton, wool, nylon, polyester, and rayon, may be exemplified.

### 4. Modification Example According to Embodiment

### 4-1. First Modification Example

The recording apparatus according to the embodiment is an on-carriage type serial printer, and may increase a large capacity of ink tank (not shown) on the outside of the printer 1. In this case, the large capacity of ink tank is connected to the ink cartridge 24 by an ink feeding tube (not shown). Therefore, like an off-carriage type printer, it is possible to greatly increase the store of color ink in the on-carriage type printer 1.

Further, the recording apparatus according to the embodiment may be an off-carriage type serial printer in which the ink cartridge is connected to the head on the carriage by a tube. In addition, the recording apparatus may be a line printer.

### 4-2. Second Modification Example

The recording apparatus according to the embodiment may be the cap member 41 in which the cleaning cap 41a and the release cap 41b are integrated.

In addition, in the recording apparatus which has been described in detail above, the cap member 41 includes the cleaning cap 41a and the release cap 41b, as shown in FIG. 2. As described above, it is possible to prevent ink, which is discharged into the cleaning cap 41a when cleaning is performed, from being attached to the nozzle plate 34 in the release state in which the head 31 moves to the release cap 41b by separately forming the cleaning cap 41a and the release cap 41b. Therefore, it is possible to prevent ink from solidifying and attaching to the nozzle plate 34 in the release state.

Further, it is possible to reduce the amount of ink which remains in the release cap 41b without discharging ink into the release cap 41b by separately forming the release cap 41b from the cleaning cap 41a. Therefore, it is possible to prevent a problem in that ink which dried and thickened in the release cap 41b absorbs the moisture of ink in the nozzles 32. In addition, it is preferable to wipe out ink which is attached to the nozzle forming surface 30 using the wiping mechanism 70 before at least a part of the nozzle forming surface 30 is covered by the release cap 41b when the recording apparatus proceeds to the release state. In this case, it is possible to further reduce the amount of ink attached to the nozzle forming surface 30.

4-3. Third Modification Example

The recording apparatus according to the embodiment may include a nozzle plate cover which is provided on the nozzle forming surface 33 on the nozzle plate 34. More specifically, in the recording apparatus, the nozzle plate cover may be provided to cover at least a part of the nozzle forming surface 33 of the head 31, and the lip unit 47 of the cap member 41 may come into contact between the nozzle plate cover and the nozzles 32.

The nozzle plate cover is provided to perform at least as either a function of fixing the chips or a function of preventing the recording medium from being raised and directly coming into contact with the nozzles 32 on the nozzle forming surface 33 of the head 31 which is formed by combining a plurality of chips. Further, the nozzle plate cover covers at least a part of the nozzle forming surface 30 and is provided in a state of protruding from the nozzles 32 when viewed from a side surface. When the nozzle plate cover is provided, even though the ink which is attached to the nozzle forming surface 33 is wiped out by performing the wiping operation, the color ink remains in an angle (gap) between the nozzle forming surface 33 and the nozzle plate cover which protrudes from the nozzle forming surface 33, and thus a problem occurs in that a capping operation becomes inferior because the remaining color ink solidifies.

Here, according to the Modification Example, when the fabric wiper 44 which adhered to the above-described impregnating solution comes into contact between the nozzle plate cover and the nozzles 32, it is possible to remove the color ink which remains in the gap, and thus the capping operation is stable and positive.

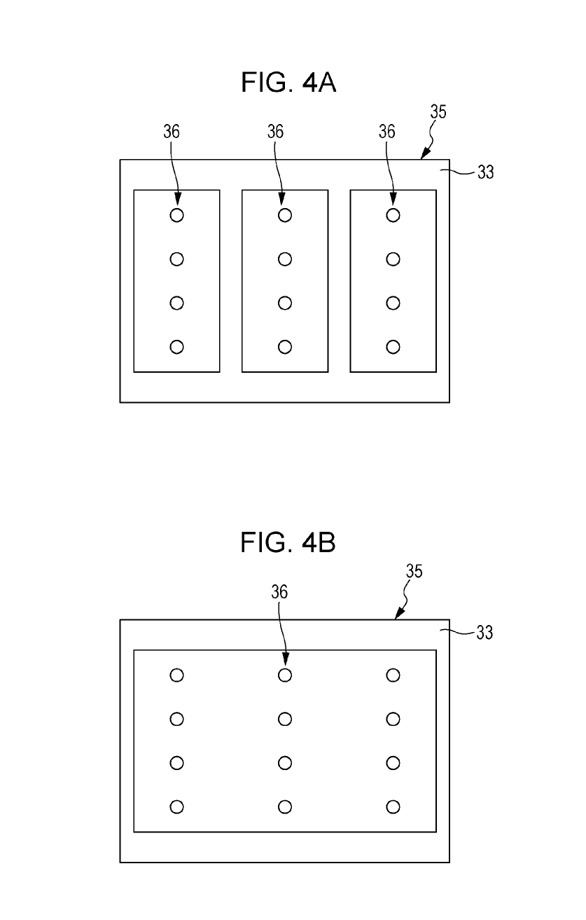

FIGS. 4A and 4B are schematic diagrams illustrating the nozzle forming surface 33 of the recording apparatus according to the embodiment. Although not limited to the installation pattern of the nozzle plate cover 35 onto the nozzle forming surface 33 below, for example, a pattern, in which the nozzle plate cover 35 is provided to surround each nozzle row 36 (the nozzle plate cover 35 is provided between the nozzle rows 36) as shown in FIG. 4A, and a pattern, in which the nozzle plate cover 35 is provided around an area where nozzles are present in order to cover the entire nozzles (it is difficult to provide the nozzle plate cover between the nozzle rows 36) as shown in FIG. 4B, may be exemplified. In addition, circles in each nozzle row 36 in FIGS. 4A and 4B correspond to the nozzles.

As described above, according to the embodiment, when recording is performed using the color ink, it is possible to provide an ink jet recording apparatus which is excellent at both continuous recording stability and cleaning performance. In addition, the recording apparatus according to the embodiment can effectively wipe out ink which solidifies on the nozzle forming surface, and excels in the cleaning performance. Further, the recording apparatus according to the embodiment is suitable for continuously recording the quick-drying color ink on, in particular, non-ink absorbable and low-absorbable recording medium using an ink jet method, and excels in continuous recording stability.

### Ink jet Recording Ink

An embodiment of the present invention relates to ink jet recording ink. The ink jet recording ink (the color ink) is suitably used for the ink jet recording apparatus according to the embodiment, and has features (1) and (2) depending on the composition thereof. (1) The ink jet recording ink composition includes first resin of heat distortion temperature 10° C. or less (hereinafter, called first ink for convenience). (2) The ink jet recording ink composition includes second resin and does not substantially include glycerin (hereinafter, called second ink for convenience).

The first ink includes the first resin of a heat distortion temperature 10° C. or less. The resin has a property which solidly adheres closely to a material, such as fabric, which has abundant flexibility and absorbability. By contrast, a coated film is rapidly formed on the resin and the solidification thereof proceeds, and thus the resin is attached to the nozzle forming surface and the absorbent material as a solid material.

The second ink does not substantially include glycerin which has a boiling point of 290° C. under 1 atmospheric pressure. If color ink substantially includes glycerin, the drying characteristic of the ink is significantly lowered. As a result, in various recording mediums, in particular, non-ink absorbable and low absorbable recording mediums, the blocky of an image is noticeable and it is difficult to obtain ink fixability. In addition, since glycerin is not included, moisture which is the main solvent in the ink rapidly volatilizes, and a percentage of organic solvent in the second ink increases. In this case, the heat distortion temperature of the resin (in particular, film forming temperature) results in fall, and solidification due to film is further quickened. Further, it is preferable to not substantially include alkyl polyols (excluding glycerin) which have a boiling point of 280° C. or greater under approximately 1 atmospheric pressure.

Here, “do not substantially include” in the specification means do not include more than the amount which sufficiently exhibits additive significance. If this is quantitatively mentioned, with regard to the total mass (100 mass %) of the color ink, it is preferable that 1.0 mass % or greater glycerin be not included, it is further preferable that 0.5 mass % or greater glycerin be not included, it is still preferable that 0.1 mass % or greater glycerin be not included, it is still preferable that 0.05 mass % or greater glycerin be not included, it is still further preferable that 0.01 mass % or greater glycerin be not included, and it is the most preferable that 0.001 mass % or greater glycerin be not included.

Hereinafter, an additive agent (component) which is included or may be included in the color ink according to the embodiment will be described.

### 1. Color Material

The color ink according to the embodiment may include a color material. The color material is selected from pigment and dyes.

### 1-1. Pigment

In the embodiment, it is possible to improve the light resistance of the color ink by using pigment as a color material. Either inorganic pigment or organic pigment may be used as the pigment. In addition, when the water repellent film is formed on the nozzle forming surface using the inorganic pigment and wiping is performed using an absorbent material which does not include a rubber blade or an impregnating solution, a problem occurs in that the water repellent film is remarkably cut. The problem further remarkably occurs when conditions, such as an average particle size is 200 nm or greater, Mohs hardness is 4.0 or greater, and the content of inorganic pigment is 5 mass % or greater, overlap. However, it is possible to suppress the problem by performing wiping using the absorbent material which uses the impregnating solution.

Although the inorganic pigment is not particularly limited, for example, carbon black, iron oxide, titanic oxide, and silica oxide may be exemplified.

Although the carbon black is not particularly limited, for example, furnace black, lamp black, acetylene black, and channel black (C.I. pigment black 7) may be exemplified. In addition, as the commercialized product of the carbon black, for example, No. 2300, 900, MCF88, No. 20B, No. 33, No. 40, No. 45, No. 52, MA7, MA8, MA100, No. 2200B (hereinbefore, all are trade names, Mitsubishi Chemical Corporation), color black FW1, FW2, FW2V, FW18, FW200, 5150, S160, 5170, Puritetsukusu 35, U, V, 140U, special black 6, 5, 4A, 4, 250 (hereinbefore, all are trade names made by Degussa AG), Conductex SC, Laben 1255, 5750, 5250, 5000, 3500, 1255, 700 (hereinbefore, all are trade names made by Columbian Carbon Japan Ltd), and Rigar 400R, 330R, 660R, moggle L, monarch 700, 800, 880, 900, 1000, 1100, 1300, 1400, Elftex 12 (hereinbefore, all are trade names made by Cabot Corporation) may be exemplified.

A single kind of inorganic pigment may be used, and two or more kinds of inorganic pigment may be combined and used.

Although the organic pigment is not particularly limited, for example, quinacridone-based pigment, quinacridone quinine-based pigment, dioxazine-based pigment, phthalocyanine-based pigment, anthrapyrimidine-based pigment, anthanthrone-based pigment, indanthrone-based pigment, flavanthrone-based pigment, perylene-based pigment, diketo-pyrrolo-pyrrole-based pigment, perinone-based pigment, quinophthalone-based pigment, anthraquinone-based pigment, thioindigo-based pigment, benzimidazolinone-based pigment, isoindolinone-based pigment, azomethine-based pigment, and azo-based pigment may be exemplified. As a specific example of the organic pigment, the followings may be exemplified.

As a pigment which is used for cyan ink, C.I. pigment blue 1, 2, 3, 15, 15:1, 15:2, 15:3, 15:4, 15:6, 15:34, 16, 18, 22, 60, 65, 66, C.I. bat blue 4, 60 may be exemplified. At least either C.I. pigment blue 15:3 or 15:4 from among them is preferable.

As a pigment which is used for magenta ink, C.I. pigment red 1, 2, 3, 4, 5, 6, 7, 8, 9, 10, 11, 12, 14, 15, 16, 17, 18, 19, 21, 22, 23, 30, 31, 32, 37, 38, 40, 41, 42, (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, 245, 254, 264, C.I. pigment violet 19, 23, 32, 33, 36, 38, 43, 50 may be exemplified. One or more kinds which are selected from a group which includes the C.I. pigment red 122, C.I. pigment red 202, and C.I. pigment violet 19 from among them are preferable.

As a pigment which is used for yellow ink, C.I. pigment yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, 180, 185, and 213 may be exemplified. One or more kinds which are selected from a group which includes the C.I. pigment yellow 74, 155, and 213 from among them are preferable.

In addition, pigment which is well known in the related art may be exemplified as pigment which is used for the other the color ink, such as green ink or orange ink.

It is preferable that the average particle size of pigment be 250 nm or less such that it is possible to suppress clogging of the nozzles and discharge stability is further excellent. In addition, the average particle size in the specification is based on volume. As a measurement method, it is possible to perform measurement by, for example, a particle distribution measurement apparatus which uses a laser diffractive scattering method as a measurement principal. As the particle distribution measurement apparatus, for example, a particle size distribution meter (for example, micro track UPA of Nikkiso Co., Ltd.) which uses a dynamic light scattering method may be exemplified.

### 1-2. Dye

In the embodiment, it is possible to use dye as the color material. The dye is not particularly limited, and acid dye, direct dye, reactive dye, and basic dye can be used.

It is preferable that the content of the color material is 0.4 to 12 mass % and it is further preferable that the content of the color material is 2 to 5 mass % with regard to the total mass (100 mass %) of the color ink.

### 2. Resin

The color ink according to the embodiment includes resin. Since the color ink includes resin, a resin coated film is formed on the recording medium, and the color ink is sufficiently fixed on the recording medium as a result, thereby producing an effect of mainly causing the scuff resistance of an image to be excellent. Therefore, it is preferable that the resin be the thermoplastic resin of resin emulsion.

The heat distortion temperature of the first resin is 10° C. or less. Further, the heat distortion temperature of the first resin is preferably −10° C. or less, and more preferably −15° C. or less. When the glass transition temperature of fixing resin is included in the ranges, it results in further excellent pigment fixability on a record, and scuff resistance is excellent. In addition, although the lowest limit of the heat distortion temperature is not particularly limited, the lowest limit of the heat distortion temperature may be 50° C. or greater.

Since it is difficult for the heat distortion temperature of the second resin to cause the head to be clogged and it is possible to make the scuff resistance of the record to be excellent, it is preferable that the lowest limit be 40° C. or greater, and it is further preferable that the lowest limit be 60° C. or greater. The preferable uppermost limit is 100° C. or less.

Here, the “heat distortion temperature” in the specification is a temperature value which is expressed using a glass transition temperature (Tg) or Minimum Film forming Temperature (MFT). That is, a “heat distortion temperature of 40° C. or greater” means that either Tg or MFT may be 40° C. or greater. In addition, since the MFT is easy to detect the merit of the redispersibility of the resin than Tg, it is preferable that the heat distortion temperature be a temperature value which is expressed using the MFT. If the color ink has excellent redispersibility of resin, the color ink is not firmly fixed, and thus it is difficult for the head 31 to be clogged.

Tg in the specification is described using a value which is measured using a differential scanning calorimetric method. In addition, MFT in the specification is a value which is measured in conformity to ISO 2115:1996 (Title: measurement of plastic-polymer distribution-white point temperature and film forming lowest temperature).

In addition, it is preferable that the acid value of the first resin be 10 to 100 mgKOH/g, and it is further preferable that the acid value of the first resin be 15 to 50 mgKOH/g. If the acid value is 100 mgKOH/g or less, it is possible to excellently maintain the cleaning toughness of a record (in particular, a printed matter). In addition, if the acid value is 10 mgKOH/g or greater, it is possible to excellently maintain the preservation stability of ink, and it is possible to excellently maintain the color developability and fixability on the recording medium.

In addition, the acid value measurement method is not particularly limited. The acid value in the specification is measured using AT610 made by Kyoto Electronics Manufacturing Co., Ltd., and it is possible to use a value which is calculated by conforming a value to the following expressing:

acid value(mg/g)=(EP1−BL1)×FA1×C1×K1/SIZE

(In the above expression, EP1 indicates titre (mL), BL1 indicates a blank value (0.0 mL), FA1 indicates the factor of volumetric solution (1.00), C1 indicates density equivalent (5.611 mg/mL) (the substantial amount of potassium hydroxide of 0.1 mol/L KOH 1 mL), K1 indicates a coefficient (1), and SIZE indicates the amount of specimen (g), respectively.)

Although the specific example of the thermoplastic resin is not particularly limited, poly(meth)acrylic acid ester and the copolymer thereof, (meth)acrylic-based polymer such as polyacrylonitrile and the copolymer thereof, polycyanoacrylate, polyacrylamide, and poly(meth)acrylic acid, polyethylene, polypropylene, polybutene, polyisobutylene, polystyrene, and the copolymer thereof, polyolefin-based polymer, such as petroleum resin coumarone-indene resin, and terpene resin, vinyl acetates and vinyl alcohol-based polymer, such as polyvinyl acetate and the copolymer thereof, polyvinyl alcohol, polyvinylacetal, and polyvinyl ether, polyvinyl chloride and the copolymer thereof, halogen-based polymer, such as polyvinylidene chloride, fluoric resin, and fluoric rubber, polyvinylcarbazole, polyvinylpyrolidone and the copolymer thereof, nitrogenous vinyl-based polymer, such as polyvinylpyridine and polyvinylimidazole, diene-based polymer, such as polybutadiene and the copolymer thereof, polychloroprene, and polyisoprene (butyl rubber), the other ring-opening polymerization-type resin, condensation polymerization-type resin, and natural high molecular resin may be exemplified. In addition, urethane-based resin is preferable to the first resin, and acrylic-based resin is preferable to the second resin.

As the commercialized product of the thermoplastic resin, for example, Hi-Tech E-7025P, Hi-Tech E-2213, Hi-Tech E-9460, Hi-Tech E-9015, Hi-Tech E-4A, Hi-Tech E-5403P, and Hi-Tech E-8237 (hereinbefore, all are trade names made by TOHO Chemical Industry Co., Ltd.), AQUQCER 507, AQUQCER 515, and AQUQCER 840 (hereinbefore, all are trade names made by BYK Japan KK), JONCRYL 67, 611, 678, 680, and 690 (hereinbefore, all are trade names made by BASF), SuperFlex 460, 470, 610, and 700 (hereinbefore, trade names made by Dai-ichi Kogyo Seiyaku Co., Ltd.), NeoRez R-9660, R-9637, and R-940 (hereinbefore, trade names made by Kusumoto Chemicals, Ltd.), Adekabontighter HUX-380 and 290K (hereinbefore, trade names made by Adeka), Takelac (registered trademark) W-605, W-635, and WS-6021 (hereinbefore, trade names made by Mitsui Chemicals, Inc.) may be exemplified.

The resin may be any of anionic, non-ionic, and cationic resin. From among this, the non-ionic or anionic resin is preferable when viewed from a material which is suitable for the head.

A single kind of resin may be used, and two or more kinds of resin may be combined and used.

It is preferable that the content of the resin be 1 to 30 mass % with regard to the total mass (100 mass %) of the color ink. In the first ink, it is preferable that the first resin be 3 to 12 mass % by taking into consideration of fixability and clogging, and it is further preferable that the first resin be 5 to 10 mass %. In contrast, in the second ink, it is further preferable that the second resin be 1 to 5 mass %. When the content is included in the ranges, it is possible to further improve the adhesiveness, gloss, and scuff resistance of an over painted image to be formed.

In addition, as resin which may be contained in the color ink, for example, a resin dispersing agent, resin emulsion, and wax may be exemplified.

### 2-1. Resin Dispersing Agent

When the pigment is contained in the color ink according to the embodiment, the color ink may include a resin dispersing agent in order to enable the pigment to be stably dispersed and maintained in water. If the color ink includes pigment which is dispersed using a resin dispersing agent, such as water-soluble resin or water dispersible resin (hereinafter, referred to as “resin dispersing pigment”), it is possible to improve adhesiveness at least either between the recording medium and the color ink or between the solidification substances of the color ink when the color ink is attached to the recording medium. The water-soluble resin is preferable from among the resin dispersing agents because it is excellent in dispersion stability.

Although not limited to water-soluble resin below, it is possible to use, for example, synthetic polymer which includes alkali metal salts, such a sulfonate group, a carboxylic group, and an amino group, and ionic hydrophilic group, such as ammonium salts, and inorganic acid salts, organic acid salts. More specifically, although not limited to below, for example, poly(meth)acrylic acid, (meth)acrylic acid-acrylonitrile copolymer, vinyl acetate-(meth)acrylic acid ester copolymer, (meth)acrylic acid-(meth)acrylic acid ester copolymer, styrene-(meth)acrylic acid copolymer, styrene-methacrylic acid-acrylic acid ester copolymer (for example, methacrylic acid-butyl acrylate-styrene-hydroxy ethyl acrylate), styrene-α-methylic styrene-(meth)acrylic acid copolymer, styrene-α-methylic styrene-(meth)acrylic acid-(meth)acrylic acid ester copolymer, styrene-maleic acid copolymer, styrene-anhydrous maleic acid copolymer, vinylnaphthalene-(meth)acrylic acid copolymer, vinylnaphthalene-maleic acid copolymer, vinyl acetate-maleic acid ester copolymer, vinyl acetate-crotonic acid copolymer, and vinyl acetate-(meth)acrylic acid copolymer, and the salts thereof may be exemplified. It is possible to use any form of random copolymer, block copolymer, alternating copolymer, and graft copolymer as a form of the copolymer.

Although not limited to salts below, salts of basic compound such as, for example, ammonia, ethylamine, diethylamine, triethylamine, propylamine, isopropylamine, dipropylamine, butylamine, isobutylamine, diethanolamine, triethanolamine, triisopropanolamine, aminomethylic propanol, and morpholine may be exemplified. If the additive amount of the basic compound is equal to or greater than the neutralization equivalent of the water-soluble resin, there is not particular limitation.

In addition, as the commercialized product of the water-soluble resin, Joncryl 67 (weight-average molecular weight: 12,500, acid value: 213), Joncryl 678 (weight-average molecular weight: 8,500, acid value: 215), Joncryl 586 (weight-average molecular weight: 4,600, acid value: 108), Joncryl 611 (weight-average molecular weight: 8,100, acid value: 53), Joncryl 680 (weight-average molecular weight: 4,900, acid value: 215), Joncryl 682 (weight-average molecular weight: 1,700, acid value: 238), Joncryl 683 (weight-average molecular weight: 8,000, acid value: 160), Joncryl 690 (weight-average molecular weight: 16,500, acid value: 240) (hereinbefore, trade names made by BASF Japan), Denka POPVAL H-12 (trade name made by Denki Kagaku Kogyo K. K., polyvinyl alcohol) may be exemplified.

Here, the water-soluble resin is not limited to the resin dispersing agent and may be used for another use. In other words, regardless of use, the color ink according to the embodiment may include the water-soluble resin.

Therefore, the water-soluble resin may be added (pre addition) in a stage in which pigment dispersion liquid is prepared before the color ink is prepared (for example, when used as a resin dispersing agent), or may be added (post-addition) as a component when the color ink is prepared (for example, when used for the purpose of improving fixability and scuff resistance).

A single kind of resin dispersing agent may be used, and two or more kinds of resin dispersing agent may be combined and used.

The additive amount corresponding to the pigment of the resin dispersing agent of the resin is preferably 1 part by mass to 100 parts by mass with regard to the pigment 100 parts by mass, and further preferably 5 parts by mass to 50 parts by mass. If the additive amount is included in the ranges, it is possible to secure excellent dispersion stability of the pigment to water.

### 2-2. Resin Emulsion

The color ink according to the embodiment may include resin emulsion in addition to the above-described thermoplastic resin. Preferably, the resin emulsion sufficiently fixes the color ink on the recording medium by forming the resin coated film together with wax, thereby producing an effect of exhibiting the excellent adhesiveness and scuff resistance of an image. A record which is recorded using the color ink which includes the resin emulsion based on the effect excels in the scuff resistance with regard to fabric when the first resin is used and with regard to the non-ink absorbable or low absorbable recording medium when the second resin is used.

In addition, the resin emulsion which functions as a binder is included in the color ink in an emulsion state. When the resin which functions as the binder is included in the color ink in the emulsion state, it is easy to adjust the viscosity of the color ink in an appropriate range in the ink jet recording system, and the resin excels in the preservation stability and discharge stability of the color ink.

Although not limited to the resin emulsion below, an independent polymer or the copolymer of, for example, (meth)acrylic acid, (meth)acrylic acid ester, acrylonitrile, cyanoacrylate, acrylamide, olefin, styrene, vinyl acetate, vinyl chloride, vinyl alcohol, vinyl ether, vinylpyrolidone, vinylpyridine, vinylcarbazole, vinylimidazole, and vinylidene chloride, fluoric resin, and natural resin may be exemplified. From among them, at least any one of (meth)acrylic-based resin and styrene-(meth)acrylic acid copolymer-based resin is preferable, at least any one of acrylic-based resin and styrene-acrylic acid copolymer-based resin is further preferable, and styrene-acrylic acid copolymer-based resin is further preferable. In addition, the copolymer may have any shape of random copolymer, block copolymer, alternating copolymer, and graft copolymer.

The resin emulsion may include a commercialized product, and may be prepared using an emulsion polymerization method as will be described below. As a method of obtaining thermoplastic resin in the color ink in an emulsion state, a method of performing emulsion polymerization on the monomer of the above-described water-soluble resin in water which includes a polymerization catalyst and an emulsifying agent may be exemplified. It is possible to use a polymeric initiator, an emulsifying agent, and a molecular weight conditioning agent which are used when the emulsion polymerization is performed according to the well-known related method.

Since the average particle size of the resin emulsion improves the preservation stability and the discharge stability of ink, preferably, the average particle size of the resin emulsion be in a range of 5 nm to 400 nm, and further preferably, be in a range of 20 nm to 300 nm.

A single kind of resin emulsion may be used, and two or more kinds of resin emulsion may be combined and used.

It is preferable that the content of the resin emulsion of the resin be in a range of 0.5 to 7 mass % with regard to the total mass (100 mass %) of the color ink. If the content is in the range, it is possible to reduce solid content density, and thus it is possible to further improve discharge stability.

### 2-3. Wax

The second ink according to the embodiment may include wax. When the color ink includes wax, the color ink further excels in fixability on the non-ink absorbable and low absorbable recording medium. Emulsion-type wax of the wax is further preferable. Although not limited to the wax below, for example, polyethylene wax emulsion, paraffin wax emulsion, and polyolefin wax may be exemplified, and the polyethylene wax emulsion which will be described later is preferable from among them. Meanwhile, the emulsion described here includes suspension shape emulsion.

In addition, the “wax emulsion” in the specification mainly means solid wax particles which are dispersed in water using a surfactant which will be described later.

It is possible to improve the scuff resistance of the ink in such a way that the color ink includes the polyethylene wax emulsion.

Although not limited to the commercialized product of the Polyethylene wax emulsion below, for example, NOPCOAT PEM-17 (a trade name made by SANNOPCO LIMITED), CHEMIPEARL W4005 (a trade name made by Mitsui Chemicals, Inc.), AQUACER 515 and AQUACER 593 (hereinbefore, trade names made by BYK) may be exemplified.

Since the average particle size of the polyethylene wax emulsion further improves the preservation stability and the discharge stability of the ink, preferably, the average particle size of the polyethylene wax emulsion be in a range of 5 nm to 400 nm, and further preferably, in a range of 50 nm to 200 nm.

The content of polyethylene wax emulsion (solid content conversion) acts independently of each other, preferably, in a range of 0.1 to 3 mass %, further preferably in a range of 0.3 to 3 mass %, and further preferably in a range of 0.3 to 1.5 mass % with regard to the total mass (100 mass %) of the color ink. If the content is in the ranges, it is possible to solidify and fix the color ink on the non-ink absorbable or low absorbable recording medium, and the preservation stability and the discharge stability of the ink are further improved.

### 3. Defoamer

The color ink according to the embodiment may include a defoamer. More specifically, it is preferable that at least either the color ink according to the embodiment or impregnating solution which will be described later include a defoamer. When the color ink includes a defoamer, it is possible to prevent the generation of foam inside the cap member 41 when the suction operation of the capping operation is performed. As a result, it is possible to prevent a problem in that foam ascends to the lip unit 47 of the cap member 41 and the foam enters the nozzles 32.

Although not limited to the defoamer below, for example, silicon-based defoamer, poly ether-based defoamer, fatty acid ester-based defoamer, and acetylene glycol-based defoamer may be exemplified. From among these, silicon-based defoamer and acetylene glycol-based defoamer are preferable because they excel in an ability to appropriately maintain surface tension and boundary tension and hardly generate foam. In addition, it is further preferable that the HLB value be 5 or less, based on a defoamer griffin method.

The color ink which includes a defoamer can appropriately maintain the boundary tension and the surface tension with the printer member, such as the nozzle forming surface of the head, which comes into contact with the color ink. Therefore, it is possible to improve the discharge stability by using the color ink which includes a defoamer for the ink jet recording system. In addition, there is a case in which a silicon-based defoamer and an acetylene glycol-based defoamer show excellent affinity (wettability) and permeability with regard to the recording medium, and a high-definition image which hardly includes stains is recorded using the color ink which includes such a defoamer.

Although the defoamer is not particularly limited, it is possible to use a commercialized product. For example, BYK-011, BYK-012, BYK-017, BYK-018, BYK-019, BYK-020, BYK-021, BYK-022, BYK-023, BYK-024, BYK-025, BYK-028, BYK-038, BYK-044, BYK-080A, BYK-094, BYK-1610, BYK-1615, BYK-1650, BYK-1730, BYK-1770 (hereinbefore, trade names made by BYK), surfynol DF37, DF110D, DF58, DF75, DF220, MD-20, and EnviroGem AD01 (hereinbefore, all are trade names made by Nissin Chemical Industry Co., Ltd.) may be exemplified.

A single kind of defoamer may be used, and two or more kinds of defoamer may be combined and used.

Since the content of a defoamer has excellent initial filling property with regard to the total mass (100 mass %) of the color ink and foam in the cleaning cap easily disappear when the negative pressure suction is performed, it is preferable that the content of a defoamer be in a range of 0.01 mass % or greater and 1 mass % or less.

### 4. Surfactant

The color ink according to the embodiment may include a surfactant (the defoamer exemplified above is excluded. That is, the surfactant is limited to a HLB value which is obtained by the griffin method and which is greater than 5). Although not limited to the surfactant below, for example, a non-ionic surfactant may be exemplified. The non-ionic surfactant performs an operation of uniformly expanding ink on the recording medium. Therefore, when ink jet recording is performed using ink which includes the non-ionic surfactant, a high-definition image which hardly includes stains is obtained. Although not limited to the non-ionic surfactant below, for example, silicons, polyoxyethylene alkyl ethers, polyoxypropylene alkyl ethers, polycyclic phenyl ethers, sorbitan derivative, and fluorine-based surfactants may be exemplified, and the silicon-based surfactant is preferable from among them.

The silicon-based surfactant excels in an operation of uniformly expanding ink such that blur is not caused on the recording medium, compared to another non-ionic surfactant.

Although the silicon-based surfactant is not particularly limited, polysiloxane-based compound is preferably exemplified. Although the polysiloxane-based compound is not particularly limited, for example, polyether denatured organosiloxane may be exemplified. As a polyether denatured organosiloxane commercialized product, for example, BYK-306, BYK-307, BYK-333, BYK-341, BYK-345, BYK-346, BYK-348, BYK-349 (hereinbefore, trade names made by BYK), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (hereinbefore, trade names made by Shin-Etsu Chemical Co., Ltd.) may be exemplified.

A single kind of surfactant may be used, and two or more kinds of surfactant may be combined and used.

It is preferable that the content of the surfactant be in a range of 0.1 mass % or greater and 3 mass % or less with regard to the total mass (100 mass %) of the ink because the preservation stability and the discharge stability of the ink is further improved.

### 5. Water

The color ink according to the embodiment may include water. In particular, when the ink is aqueous ink, water is the main medium of the ink, and is a component which is evaporation-scattered when the recording medium is heated in the ink jet recording.

As water, for example, water from which ionic impurities are removed as much as possible, like pure water, such as ion-exchange water, ultrafiltrate, reverse seepage water, and distilled water, and ultrapure water, may be exemplified. In addition, if water, which is sterilized by performing ultraviolet light irradiation or adding hydrogen peroxide, is used, it is possible to prevent molds or bacterium from breaking out when the pigment dispersion liquid or ink, in which the pigment dispersion liquid is used, is preserved for a long time.

The content of water is not particularly limited, and may be appropriately determined as necessary.

### 6. Organic Solvent

The color ink according to the embodiment may include volatile water-soluble organic solvent. However, as described above, it is preferable that the color ink according to the embodiment do not substantially include glycerin (which has a boiling point of 290° C. under approximately 1 atmospheric pressure) which is one kind of the organic solvent, and do not substantially include alkyl polyols (excluding glycerin) which has a boiling point of 280° C. or greater under approximately 1 atmospheric pressure.

Although not limited to the organic solvent below, for example, an alcohol class or a glycol class, such as ethyleneglycol, diethyleneglycol, triethyleneglycol, propyleneglycol, dipropyleneglycol, 1,3-propanediol, 1,2-butanediol, 1,2-pentanediol, 1,2-hexanediol, 1,4-butanediol, 1,5-pentanediol, 1,6-hexanediol, diethyleneglycol mono-n-propyl ether, ethyleneglycol mono-iso-propyl ether, diethyleneglycol mono-iso-propyl ether, ethyleneglycol mono-n-butyl ether, ethyleneglycol mono-t-butyl ether, diethyleneglycol mono-n-butyl ether, triethyleneglycol mono-n-butyl ether, diethyleneglycol mono-t-butyl ether, propyleneglycol mono methylic ether, propyleneglycol mono ethyl ether, propyleneglycol mono-t-butyl ether, propyleneglycol mono-n-propyl ether, propyleneglycol mono-iso-propyl ether, propyleneglycol mono-n-butyl ether, dipropyleneglycol mono-n-butyl ether, dipropyleneglycol mono-n-propyl ether, dipropyleneglycol mono-iso-propyl ether, diethyleneglycol dimethylic ether, diethyleneglycol diethyl ether, diethyleneglycol dibutyl ether, diethyleneglycol ethyl methylic ether, diethyleneglycol butylmethylic ether, triethyleneglycol dimethylic ether, tetraethyleneglycol dimethylic ether, dipropylene glycol dimethylic ether, dipropyleneglycol diethyl ether, tripropyleneglycol dimethylic ether, methanol, ethanol, n-propylalcohol, iso-propylalcohol, n-butanol, 2-butanol, tert-butanol, iso-butanol, n-pentanol, 2-pentanol, 3-pentanol and tert-pentanol, N,N-dimethylic formamide, N, N-dimethylic acetoamide, 2-pyrolidone, N-methylic-2-pyrolidone, 2-oxazolidone, 1,3-dimethylic-2-imidazolidinone, dimethylic sulfoxide, sulfolane, and 1,1,3,3-tetramethylic urea may be exemplified.

A single kind of organic solvent may be used, and two or more kinds of organic solvent may be combined and used. The content of the organic solvent is not particularly limited and may be appropriately determined as necessary.

### 7. pH Adjuster

The color ink according to the embodiment may include a pH adjuster. As the pH adjuster, for example, inorganic alkali such as sodium hydroxide or potassium hydroxide, ammonia, diethanolamine, triethanolamine, triisopropanolamine, morpholine, potassium dihydrogen phosphate, and disodium hydrogen-phosphate may be exemplified.

A single kind of pH adjuster may be used, and two or more kinds of pH adjuster may be combined and used. The content of the pH adjuster is not particularly limited and may be appropriately determined as necessary.

### 8. Other Components

The color ink according to the embodiment may further include a preservative, a fungicide, a corrosion inhibitor, and a chelator in addition to the components.

### 9. Color Ink Manufacturing Method

The color ink according to the embodiment can be obtained by mixing the above-described components (materials) in arbitrary order, performing filtration as necessary, and removing impurities. Here, it is preferable that pigment be prepared in a state in which the pigment is uniformly dispersed in a solvent in advance, and then be mixed for easy treatment.

As a method of mixing each of the materials, a method of substantially adding materials to a container which includes a stirrer apparatus, such as a mechanical stirrer or a magnetic stirrer, and mixing the materials is used. It is possible to perform, for example, centrifugal filtration or filter filtration, as necessary, as a filtration method.

### Impregnating Solution

The embodiment of the present invention relates to an impregnating solution. The impregnating solution is suitably used for the ink jet recording apparatus according to the embodiment, and is included (perfused) in a fabric wiper.

Although not limited to the additive agent (component) which may be included in the impregnating solution below, for example, resin, a defoamer, water, an organic solvent, a wetting agent, and a pH adjuster may be exemplified. With regard to additive agents excepting the wetting agent of these additive agents (components), contents which have been described in the above-described ink jet recording ink paragraph can be cited, and thus the description thereof is omitted. In addition, a single kind of each of the components excepting the wetting agent which will be described later may be used and two or more kinds of components may be combined and used, and the content thereof is not particularly limited. In addition, it is assumed that the organic solvent does not include the wetting agent which will be described later.

When a defoamer of the additive agents which may be included in the impregnating solution is supplemented, it is preferable that at least any one of the above-described color ink and the impregnating solution include a defoamer. When the impregnating solution includes the defoamer, it is possible for the impregnating solution, which remained on the nozzle forming surface after the wiping process is performed, to effectively prevent the lip unit of the cap member from being foamed.

In addition, when the pH adjuster of the additive agents which may be included in the impregnating solution is supplemented, it is preferable that the impregnating solution include the pH adjuster. There is a case in which the impregnating solution includes a lot of acid wetting agents such as polyethyleneglycol and glycerin. If such an acid impregnating solution comes into contact with the color ink (usually, a basic color ink of pH 7.5 or greater), there is a possibility that the color ink shifts to an acid side, and that the preservation stability of the color ink is damaged. Here, the preservation stability of the color ink is improved in such a way that the impregnating solution includes the pH adjuster.

In addition, the wetting agent (moisturizer) of the additive agents which are included in the impregnating solution will be described. If the wetting agent can be generally used for ink, the wetting agent is not particularly limited and can be used. A high boiling point wetting agent, which has a boiling point of preferably 180° C. or greater, and, more preferably 200° C. or greater under approximately 1 atmospheric pressure, is used. If the boiling point is included in the ranges, it is possible to prevent the volatile element in the impregnating solution from violating, and it is possible to securely moisten the color ink which comes into contact with the impregnating solution and effectively wipe it out.

Although a specific example of a high-boiling point wetting agent is not particularly limited, ethyleneglycol, propyleneglycol, diethyleneglycol, triethyleneglycol, pentamethylene glycol, trimethyleneglycol, 2-butene-1,4-diol, 2-ethyl-1,3-hexanediol, 2-methylic-2,4-pentanediol, tripropyleneglycol, polyethyleneglycol having an average molecular weight of 2000 or less, 1,3-propyleneglycol, isopropyleneglycol, isobutyleneglycol, glycerin, meso-erythritol, and penta-erythritolmay be exemplified.

A single kind of wetting agent may be used or two kinds or more wetting agents may be combined and used. It is preferable that the content of the wetting agent be 10 to 100 mass % with regard to the total mass (100 mass %) of the impregnating solution. In addition, the content of the wetting agent which is 100 mass % with regard to the total mass of the impregnating solution indicates that the entire component of the impregnating solution is wetting agent.

### EXAMPLES

Hereinafter, although the present invention will be described in detail using Examples, the present invention is not limited thereto.

### 1. Material of Color Ink

The main materials for color ink preparation which are used in the following Examples and Comparison Examples are as follows:

### Pigment

C.I. Pigment Black 7 (Carbon Black)

### Resin Emulsion

Styrene-acrylic acid copolymer-based resin emulsion A (Tg 85° C., an average particle size of 140 nm, hereinafter, described as “styrene-acrylic acid resin emulsion A”)
Styrene-acrylic acid copolymer-based resin emulsion B (Tg 30° C., an average particle size of 120 nm, hereinafter, described as “styrene-acrylic acid resin emulsion B”)
Urethane resin emulsion “anionic urethane resin emulsion having a Tg of 20° C., an acid value of 25 or less, and an average particle size of 100 nm”

### Polyethylenewax Emulsion

AQUACER 515 (trade name made by BYK)

### Silicon-Based Surfactant

BYK 348 (trade name made by BYK)
   Acethylene glycol-based defoamer
Surfynol DF110D (trade name made by Nissin Chemical Co., Ltd., griffin HLB value=3)

### Organic Solvent

1,2-Hexanediol
2-Pyrolidone
Propylene glycol
Triethylene Glycol Mono Butyl Ether

### pH Adjuster

Triethanolamine

### 2. Preparation of Pigment Dispersion Liquid for Color Ink

A water-soluble resin (which is copolymerized at a mass ratio of methacrylic acid/butyl acrylate/styrene/hydroxy ethyl acrylate=25/50/15/10. weight-average molecular weight 12,000) 40 parts by mass is poured into liquid obtained by mixing a potassium hydroxide parts by mass, a water 23 parts by mass, and a triethyleneglycol-mono-n-butyl ether 30 parts by mass, and heated while being stirred at a temperature of 80° C., thereby preparing a resin water solution.

A mixed liquid is obtained in such a way that a C.I. pigment black 7 of 3.0 kg and a water of 10.25 kg are mixed with a resin water solution (solid content 43%) of 1.75 kg, respectively, and premixsing is performed by stirring it using a mixed stirrer. The mixed liquid is dispersed by a multi-pass system using a horizontal-type bead mill which includes a multi-disk type impeller having an effective volume of 1.5 liters with which 85% zirconia bead of 0.5 mm is filled. More specifically, a pigment dispersed and mixed liquid having an average particle size of 325 nm is obtained by performing two passes at a bead peripheral speed of 8 m/sec with a discharge amount of 30 liters for an hour. Subsequently, the pigment dispersed and mixed liquid is circulated and dispersed using a horizontal and annular-type bead mill which includes an effective volume of 1.5 liters with which 95% zirconia bead of 0.05 mm is filled. An aqueous pigment dispersion liquid having a pigment solid content of 20% and a water-soluble resin of 5% is obtained in such a way that a screen of 0.015 mm is used, and a dispersion process is performed on an amount of pigment dispersed and mixed liquid of 10 kg for four hours at a bead peripheral speed of 10 m/sec and a circulatory volume of 300 liter/h.

### 3. Preparation of Color Ink

An amount of prepared pigment dispersion liquid which causes the C.I. pigment black 7 to be 2.5 mass % is prepared. Ink 1 and ink 2 (total 100.0 mass %) are prepared in such a way that each of the components expressed in Table 1 below excepting the “carbon black” is added to the pigment dispersion liquid so as to meet the content (unit: mass %) described in Table 1 below. Each color ink is prepared in such a way that, after each component is put into a container and stirred and mixed using a magnetic stirrer for 2 hours, and foreign matters (impurities), such as dust and coarse particles, are removed by performing filtration using a membrane filter having a pore size of 5 μm.

TABLE 1

| Material | Material | Ink | Ink | Ink | Ink |
|---|---|---|---|---|---|
| kind | name | 1 | 2 | 3 | 4 |
| Pigment | Carbon black | 2.5 | 2.5 | 4 | 4 |
| Organic | 1,2-hexanediol | 5 | 5 | 5 | 5 |
| solvent | 2-pyrolidone | 15 | 15 | 10 | 5 |
| | Triethyleneglycol | — | — | 1 | 3 |
| | Monobutyl ether | | | | |
| | Glycerine | — | — | 10 | 10 |
| | Propyleneglycol | 10 | 10 | 2 | 5 |
| Resin | Styrene-acrylic acid | 1 | 1 | — | — |
| | resin emulsion A | | | | |
| | Styrene-acrylic acid | — | — | — | 3 |
| | resin emulsion B | | | | |
| | Polyethylenewax | 0.5 | 0.5 | — | — |
| | Urethane resin | 0.5 | 0.5 | 6 | — |
| | emulsion | | | | |
| Surfactant | Silicon-based | 0.5 | 0.5 | 1 | 1 |
| | surfactant | | | | |
| Defoamer | Acethylene glycol- | 0.2 | — | 0.2 | 0.2 |
| | based defoamer | | | | |
| pH adjuster | Triethanolamine | 0.2 | 0.2 | 0.2 | 0.2 |
| Water | Pure water | Residue | Residue | Residue | Residue |
| | Total | 100 | 100 | 100 | 100 |

### 4. Material for Impregnating Solution

Subsequently, the main materials for impregnating solutions which are used in the following Examples and Comparison Examples are as follows:

### Wetting Agent

Polyethyleneglycol (PEG)
Glycerin

### pH Adjuster

Triethanolamine

### Acethylene Glycol-Based Defoamer

Surfynol DF110D (trade name made by Nissin Chemical Co., Ltd., an HLB value obtained using the griffin method=3)

### Organic Solvent

1,2-Hexanediol

### 5. Preparation of Impregnating Solution

Each of the components shown in Table 2 below is added to be the content (unit: mass %) described in Table 2 below, and impregnating solutions 1 and 2 are prepared (total 100.0 mass %). Each impregnating solution is prepared in such a way that, after each component is poured into a container and stirred and mixed by a magnetic stirrer for 2 hours, and impurities, such as dust or coarse particles, are removed by performing filtration using a membrane filter having a pore size of 5 μm.

TABLE 2

| | | Impreg- | Impreg- | Impreg- |
|---|---|---|---|---|
| Material | Material | nating | nating | nating |
| kind | name | solution 1 | solution 2 | solution 3 |
| Organic | 1,2-hexanediol | 5 | 5 | 5 |
| solvent | | | | |
| Water | Pure water | 20 | 20 | — |
| pH adjuster | Triethanolamine | 0.5 | 0.5 | 0.5 |
| Defoamer | Acethylene glycol- | 0.2 | 0.2 | 0.2 |
| | based defoamer | | | |
| Wetting | Polyethylenew | residue | — | — |
| agent | glycol | | | |
| | Glycerine | — | residue | residue |
| | Total | 100 | 100 | 100 |

### 6. Ink Jet Recording

A printer which is obtained by reconstructing printer PX-H10000 (made by Seiko Epson Corporation) is used. The reconstructed points include a point that a print head is provided with a water-repellent film attached silicon nozzle plate and a nozzle plate cover which are manufactured as below, and a point that the lip unit of a cap member is made of butyl rubber.

The silicon nozzle plate is formed of a single crystal silicon. On the surface of the ink discharge side of the plate, an oxidized silicon film (a SiO₂ film), which is formed using a Chemical Vapor Deposition (CVD) method in such a way that SiCl₄ and water vapor are introduced to a CVD reactor, is formed. The thickness of the SiO₂ film is nm. Further, a water repellent film is formed on the SiO₂ film in such a way that an oxygen plasma process is performed, and, thereafter, the CVD is performed using C₈F₁₇C₂H₄SiCl₃, thereby manufacturing a water repellent film-attached silicon nozzle plate.

With regard to Examples 1 to 4 and Comparison Examples 1 and 2, a vinyl chloride film (a trade name “LLSP EX113” made by Sakurai co., ltd.), which functions as a recording medium located in an area to which the discharged color ink is attached, is heated up to 50° C. using an infrared heater installed in the reconstructed printer. The temperature is measured by a thermograph using an infrared thermographic apparatus H2640/H2630 (NEC Avio infrared technology co., ltd). In addition, the measured temperature is the temperatures of the surface of the recording medium (recording target surface) which comes into contact with the color ink.

With regard to Example 5 and Comparison Example 3, a preprocessing liquid which includes calcium oxide is applied to a cotton 100% T-shirt, and the discharge is performed using the reconstructed printer described in. With regard to Reference Example, the discharge is performed using the reconstructed printer described in on a professional photo paper (Seiko Epson Corp).

### 7. Examples 1 to 5, Comparison Examples 1 to 3, and Reference Examples

Continuous printing is performed for one hour using the color ink shown in the following Tables 3 and 4. Thereafter, the suction process and the flushing process are performed by the capping operation, and the wiping process is performed using the wiping member which includes impregnating solutions shown in the following Tables 3 and 4 (the cap cleaning is performed). Subsequently, each of the following evaluations is performed when continuous printing is performed for one hour and cap cleaning is sequentially performed again. Evaluated items and an evaluation method are as follows:

### 7-1. Continuous Recording Stability

The presence of dead pixels and the presence of landing deviation of color ink, which is discharged from nozzles, are observed when print is performed on seven vinyl chloride films each having an A1 size, 30 T-shirts, and a professional photo paper of 10 m. In addition, when the evaluation of continuous recording stability is high, it means that it is possible to excellently clean substances which disturb the discharge of ink in the head.

Evaluation reference is as follows. Evaluation results are shown in Table 3.

A: There is no nozzle omission and landing deviation is not viewed.
B: Although there is no nozzle omission, landing deviation is viewed.
C: Both nozzle omission and landing deviation are viewed.

### 7-2. Cleaning Performance

An image, obtained when continuous print starts again after first cap cleaning is performed, is evaluated.

Evaluation reference is as follows. Evaluation results are shown in Table 3.

A: There is no nozzle omission and landing deviation is not viewed.
B: Although there is no nozzle omission, landing deviation is viewed.
C: Both nozzle omission and landing deviation are viewed.

TABLE 3

| | Example | Example | Example | Example | Example |
|---|---|---|---|---|---|
| | 1 | 2 | 3 | 4 | 5 |
| Color ink | Ink 1 | Ink 2 | Ink 1 | Ink 1 | Ink 3 |
| No. | | | | | |
| Impreg- | Impreg- | Impreg- | Impreg- | Impreg- | Impreg- |
| nating | nating | nating | nating | nating | nating |
| solution No. | solution 1 | solution 2 | solution 2 | solution 3 | solution 1 |
| Wiping | Fabric | Fabric | Fabric | Fabric | Fabric |
| member | wiper | wiper | wiper | wiper | wiper |
| Continuous | A | A | A | A | A |
| recording | | | | | |
| stability | | | | | |
| evaluation | | | | | |
| Cleanness | A | B | A | A | A |
| evaluation | | | | | |

TABLE 4

| | Comparison | Comparison | Comparison | Reference |
|---|---|---|---|---|
| | Example 1 | Example 2 | Example 3 | Example |
| Color ink | Ink 1 | Ink 1 | Ink 3 | Ink 4 |
| No. | | | | |
| Impreg- | None | None | None | None |
| nating | | | | |
| solution No. | | | | |
| Wiping | Blade | Fabric | Fabric | Blade |
| member | wiper | wiper | wiper | wiper |
| Continuous | C | B | B | A |
| recording | | | | |
| stability | | | | |
| evaluation | | | | |
| Cleanness | C | B | B | A |
| evaluation | | | | |

From the above-results, it is apparent that both continuous recording stability and cleaning performance are excellent in the ink jet recording apparatus (each Example) including a head that discharges specific color ink from the nozzles which are formed on the nozzle forming surface toward a recording medium, a wiping mechanism that wipes out ink which is attached to a nozzle forming surface using an absorbent material having an impregnating solution, and a cap member that adheres closely to the nozzle forming surface in a state in which a space is included in an area facing the nozzles, and removes at least ink of the space, compared to another recording apparatus (each Comparison Example).

What is claimed is:

1. An ink jet recording apparatus comprising at least:
a print head that discharges ink jet recording ink from nozzles which are formed on a nozzle forming surface toward a recording medium;
a wiping mechanism that wipes out ink which is attached to a nozzle forming surface using an absorbent material having an impregnating solution; and
a cap member that adheres closely to the nozzle forming surface in a state in which a space is included in an area facing the nozzles, and removes at least ink of the space,
wherein the ink jet recording apparatus further comprises the following characteristic (1) or (2).
1) ink jet recording ink composition includes a first resin having a heat distortion temperature of 10° C. or less.
2) ink jet recording ink composition includes a second resin and includes substantially no glycerin.

2. The ink jet recording apparatus according to claim 1, wherein, in a case where the ink jet recording apparatus comprises the characteristic (2), the heat distortion temperature of the first resin is 60° C. or greater, and the ink jet recording apparatus further comprises a heating mechanism that heats a recording medium which is transported to a position facing the print head.

3. The ink jet recording apparatus according to claim 1, wherein, in a case where the ink jet recording apparatus comprises the characteristic (1), a second resin content of the ink composition is 3 mass % or greater.

4. The ink jet recording apparatus according to claim 1,
wherein at least any one of the ink jet recording ink or the impregnating solution includes a defoamer.

5. The ink jet recording apparatus according to claim 1,
wherein the cap member makes a smaller contact angle with the ink jet recording ink than the nozzle forming surface.

6. The ink jet recording apparatus according to claim 1,
wherein a nozzle plate cover which covers at least a part of the nozzle forming surface is provided on the nozzle forming surface, and a lip unit of the cap member comes into contact between the nozzle plate cover and the nozzles.

7. The ink jet recording apparatus according to claim 1,
wherein the cap member includes:
a cleaning cap which sucks the ink jet recording ink in the print head in a state in which at least a part of the nozzle forming surface is covered; and
a release cap which comes into contact with the nozzle forming surface and covers at least the part of the nozzle forming surface in a release state in which a recording operation of the ink jet recording apparatus is stopped, unlike the cleaning cap.

8. The ink jet recording apparatus according to claim 7,
wherein, when the recording apparatus proceeds to the release state, that is, before at least the part of the nozzle forming surface is covered by the release cap, ink which is attached to the nozzle forming surface is wiped out using the wiping mechanism.
